(19) United States
(12) Patent Application Publication
(10) Pub. No.: US 2009/0270558 A1
(43) Pub. Date: Oct. 29, 2009

(54) Functionalized Polyvinylaromatic Nanoparticles

(75) Inventors: Sylvie Gandon-pain, Clermont-Ferrand (FR); Alain Hut, Le Cendre (FR); Arnaud Lapra, Saint-Saturnin (FR)

Correspondence Address: BUCHANAN, INGERSOLL & ROONEY PC, POST OFFICE BOX 1404, ALEXANDRIA, VA, 22313-1404, US

(73) Assignee: Michelin Recherche et Technique S.A., Granges-Paccot (CH)

(21) Appl. No.: 11/794,502

(22) PCT Filed: Dec. 30, 2005
(86) PCT No.: PCT/EP2005/014134

§ 371 Date: Jun. 29, 2007

(30) Foreign Application Priority Data
Dec. 31, 2004 (FR) 0414125

(51) Int. Cl. C08L 25/00; C08F 130/08; C08F 212/08

(52) U.S. Cl. 525/190; 526/279; 525/185; 525/209

(57) ABSTRACT

Nanoparticles of a functionalized and crosslinked polyvinylaromatic (PVAr) that may be used as reinforcing filler in a polymeric composition, the PVAr being a copolymer of at least:
a vinylaromatic comonomer “A”;
   a comonomer “B” carrying a functional group denoted by Z of formula ≡Si—X, X representing a hydroxyl or hydrolyzable group;
   a crosslinking comonomer “C” which is at least bifunctional and polymerizable by means of an addition reaction, it being possible for comonomer C to be vinylaromatic, in this case identical or different to comonomer A or non-vinylaromatic.
      The PVAr comprises, for example, a copolymer of styrene, ethylvinylbenzene, divinylbenzene and trimethoxysilylpropyl(meth)acrylate, being in the form of nanobeads, the diameter of which is between 10 and 100 nm. This PVAr filler, thanks to a very low density, allows the weight of polymeric compositions, especially elastomer compositions, to be reduced without degrading the reinforcement, and with an notable reduction in hysteresis.

The present invention relates to reinforcing fillers capable of reinforcing polymeric matrices, more particularly to reinforcing fillers of the organic type, and also to their use for reinforcing such rubber compositions, especially elastomeric matrices involved in the manufacture of tires for motor vehicles.

To reduce fuel consumption and the pollution emitted by motor vehicles, considerable effort has been spent by tire designers to obtain tires having a very low running resistance, improved grip on dry, wet or snow-covered ground, and good wear resistance. One effective solution to this problem has been found, over the course of the last fifteen years, by developing novel fillers of the inorganic but truly reinforcing type, also known by the name of “non-black fillers”, most particularly HDS (Highly Dispersible Silica) fillers, which have proved to be capable of replacing in their reinforcing filler function the conventional carbon blacks for tires.

However, these inorganic reinforcing fillers, because of a slightly higher density for an equivalent reinforcing power, have the known drawback of increasing the weight of the polymeric matrices that they reinforce, compared with the use of carbon black. This goes somewhat counter to another more general objective, that of lightening tires and therefore vehicles containing them.

By continuing their research, the Applicants have discovered certain synthetic organic fillers which may unexpectedly be used in these compositions as true reinforcing fillers, that is to say capable of replacing conventional carbon blacks for tires, such as HDS silicas.

These novel organic synthetic fillers, thanks to having a density about half as great, allow the weight of polymeric matrices that they reinforce and that of polymer articles containing them, especially rubber articles such as tires to be very significantly reduced, without compromising the usage properties of these articles.

Consequently, a first subject of the invention is nanoparticles of a functionalized and crosslinked polyvinylaromatic (hereafter abbreviated to “PVAr”) which may be used in particular as a reinforcing filler in a polymeric matrix, characterized in that said polyvinylaromatic is a copolymer of at least:
a vinylaromatic comonomer “A”;
a comonomer “B” carrying a functional group denoted by Z of formula ≡Si—X, X representing a hydroxyl or hydrolyzable group;
a crosslinking comonomer “C” which is at least bifunctional and polymerizable by means of an addition reaction, it being possible for comonomer C to be vinylaromatic, in this case identical or different to comonomer A or non-vinylaromatic.

The subject of the invention is also the use of nanoparticles according to the invention for reinforcing a polymeric, especially elastomeric, matrix.

The subject of the invention is also the use of nanoparticles according to the invention for the reinforcement of finished articles or semi-finished products made of rubber, these articles or semi-finished products being especially intended for any ground-contacting system for motor vehicles, such as tires, internal safety supports for tires, wheels, rubber springs, elastomeric joints, and other suspension and anti-vibration elements.

The subject of the invention is most particularly the use of nanoparticles according to the invention for the reinforcement of tires.

The subject of the invention is also a masterbatch comprising nanoparticles according to the invention, which are embedded in a polymeric, especially elastomeric, matrix.

The subject of the invention is also a masterbatch based on at least one diene elastomer and a polymeric filler comprising the above Z-functionalized PVAr nanoparticles.

The subject of the invention is also a process for or method of obtaining such a masterbatch comprising at least a polymer, especially an elastomer and a filler in the form of nanoparticles, said method comprising the following steps:
a latex of the polymer and a latex of the filler in the form of nanoparticles are initially obtained;
the latices are intimately mixed;
the mixture thus obtained is precipitated; and
the precipitate thus obtained is then washed and dried,
   and being characterized in that said filler comprises nanoparticles of the above Z-functionalized PVAr.

The subject of the invention is also a polymeric composition comprising at least one polymer, especially an elastomer, nanoparticles according to the invention and a coupling agent for bonding between the polymer and the surface of the nanoparticles.

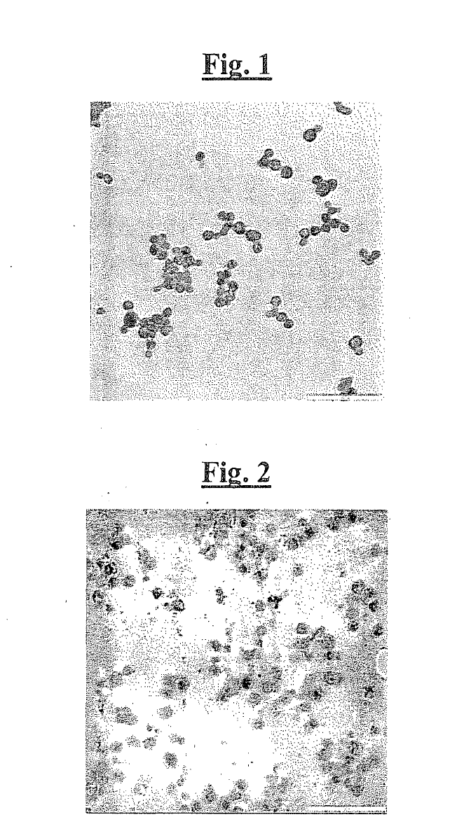

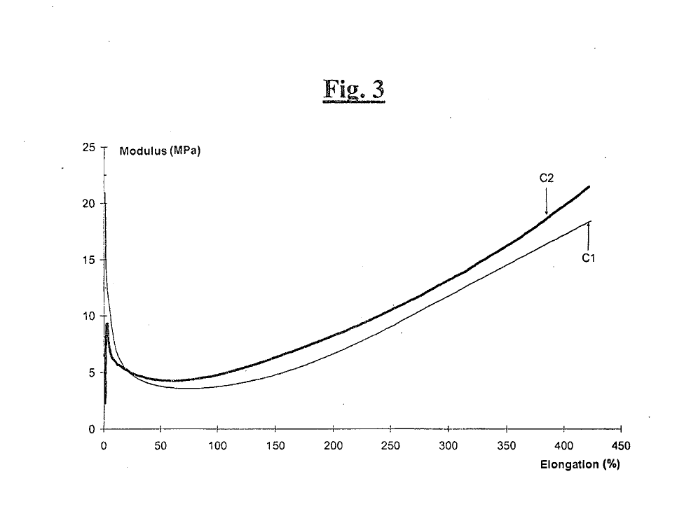

The invention and its advantages will be readily understood in the light of the description and exemplary embodiments that follow, and also from the figures relating to these embodiments, which represent:
a TEM (transmission electron microscope) micrograph of a PVAr nanoparticles specimen in aqueous emulsion, according to the invention (FIG. 1);
a TEM micrograph of a specimen of a rubber composition reinforced by these PVAr nanoparticles (FIG. 2); and
curves showing the variation of the modulus as a function of the elongation for various rubber compositions reinforced or not reinforced by the nanoparticles of the invention (FIG. 3 to FIG. 5).

### I. MEASUREMENTS AND TESTS USED

### I-1. Characterization of the PVAr Filler

The PVAr filler described above consists of nanoparticles, that is to say particles whose main dimension (diameter or length) is typically less than 1 micron and generally lies within the range of the order of about ten nanometers to a hundred or several hundred nanometers.

These nanoparticles are in the form of elementary particles (or “primary particles”), these elementary particles or nanoparticles possibly forming aggregates (or “secondary particles”) of at least two of these nanoparticles, it being possible, optionally, for the nanoparticles and/or aggregates to form in turn agglomerates that may be broken up into these nanoparticles and/or aggregates under the effect of an external force, for example under the action of mechanical work.

These nanoparticles are characterized by transmission electron microscopy (TEM), as indicated below.

A) Characterization in Emulsion (Latex):

The PVAr filler latex, prediluted with water (for example 8 g of filler per liter of water) is diluted about 50 times in isopropanol. 40 ml of the solution thus obtained are poured into a tall beaker (50 ml volume) and then dispersed using a 600 W ultrasonic probe (Vibracells probe, reference 72412, sold by Bioblock Scientific), under a power of 100% for 8 minutes in pulsed mode (1 s on/1 s off). A drop of the solution thus obtained is then deposited on a copper microscope grid with a carbon membrane and then observed under a TEM (CM 200 sold by FEI; accelerating voltage 200 kV) equipped with a camera (MegaView II camera sold by Soft Imaging System) and with an image analysis system (Analysis Pro A, version 3.0 from Soft Imaging System).

The TEM adjustment conditions are optimized in a known manner according to the specimen and the state of aging of the filament (typically, condenser diaphragm 2 (50 μm in diameter) and objective 3 (40 μm in diameter)). The magnification of the microscope is adapted so as to have sufficient resolution on the nanoparticles. For example, a magnification of 65000 corresponds to a resolution of about 0.96 nm/pixel on the digital image consisting of 1248×1024 pixels. Such a resolution makes it possible for example to define a 40 nm-diameter spherical nanoparticle with more than 1000 pixels. The camera is calibrated conventionally using standards (at low magnification, a gold grid consisting of 2160 lines/mm; at high magnification, gold balls 0.235 nm in diameter).

The diameter of the nanoparticles is measured using Analysis Pro A version 3.0 software (with the “Cercle” option from the “Mesure” menu). For each image and for a given nanoparticle, the operator defines on the screen (using the mouse) three points located on the periphery of the image of the nanoparticle. The software then automatically plots the circle that passes through these three points and stores, in a file (Excel), the values of the circle area, the circle circumference and the circle diameter of the nanoparticle. As this operation is possible only for nanoparticles having well-defined contours, nanoparticles present in agglomerates are excluded from the measurement. The experiment is repeated at a minimum of 2000 nanoparticles representative of the specimen (obtained from at least 10, typically 50, different images).

B) Characterization in Rubber Composition Form:

The PVAr filler specimens, in vulcanized rubber composition form, are prepared in a known manner by ultracryomicrotomy (see for example L. Sawyer and D. Grubb, Polymer Microscopy, page 92, Chapman and Hall).

The apparatus used here is a Leica ultracryomicrotome (EMFCS) equipped with a diamond knife. The specimen is cut in the form of a truncated pyramid of rectangular base, the truncated face from which the sections are produced having sides of less than 600 μm. This truncated pyramid is held firmly during the cutting operation. The specimen is cooled to a suitable temperature (close to the glass transition temperature of the specimen) so that it is hard enough to be able to cut it, the temperature of the knife being typically close to that of the specimen. The speed and the thickness of the cut (as displayed by the apparatus) are preferably between 1 and 2 mm/s and between 20 and 30 nm, respectively. Using a drop of aqueous saccharose solution (40 g in 40 ml of water), the sections are recovered in the chamber of the ultracryomicrotome and then deposited on a TEM grid at room temperature. The saccharose is then eliminated by depositing the grid on the surface of a crystallizer filled with distilled water.

The sections are observed in a CM 200 microscope (200 kV voltage). To optimize the contrast, the observations are made in conventional energy-filtered imaging (ΔE energy window equal to about 15 eV), with a GIF (Gatan Imaging Filter) imaging system and associated software (Filter Control and Digital Micrograph 3.4).

### II. DETAILED DESCRIPTION OF THE INVENTION

In the present description, unless otherwise indicated, all the percentages (%) indicated are % by weight.

### II-1. Nanoparticles of PVAr

The nanoparticles of the invention have the essential feature of consisting of a functionalized and crosslinked PVAr, said PVAr being a copolymer of at least:
a vinylaromatic comonomer “A”;
a comonomer “B” carrying a functional group denoted by Z of formula (I): ≡Si—X, in which X represents a hydroxyl or hydrolyzable monovalent group;
a crosslinking comonomer “C” which is at least bifunctional and polymerizable by means of an addition reaction, it being possible for comonomer C to be vinylaromatic, identical or different to comonomer A or non-vinylaromatic.

A person skilled in the art will readily understand on examining the above formula (I) that there exists at least one and at most three hydroxyl or hydrolyzable monovalent groups X connected to the PVAr via the tetravalent silicon atom.

The term “polyvinylaromatic” (PVAr) is understood in the present invention to mean, by definition:
any homopolymer of a vinylaromatic compound (i.e. by definition any vinyl monomer substituted in the α-position with an aromatic group); or
   any copolymer, at least a predominant fraction of which (preferably at least 50% or higher, and more preferably 70% or higher) comprises vinylaromatic groups, it being possible for the minor fraction (preferably less than 50%, more preferably less than 30%) to derive from one or more monomers of another nature.

Particularly suitable as vinylaromatic compounds are: any styrene compound (by definition any monomer containing the styryl radical) such as for example styrene, 2-methylstyrene, 3-methylstyrene, 4-methylstyrene, α-methylstyrene, 2,4-diimethylstyrene, 2,4-diisopropylstyrene, 4-tert-butylstyrene, methoxystyrene, tert-butoxystyrene, chlorostyrene and chloromethylstyrene. As other preferred examples of styrene compounds, ethylvinylbenzene (hereafter abbreviated to EVB), divinylbenzene (DVB) and their various isomers may be mentioned.

Preferably, in formula (I) above, X is a halogen, especially chlorine, or X satisfies the formula OR in which O is oxygen and R represents hydrogen or a monovalent, linear or branched, hydrocarbon group preferably containing 1 to 15 carbon atoms.

Particularly suitable are Z functional groups chosen from functional groups called “hydroxysilyl” (≡Si—OH) or “alkoxysilyl” (≡Si—OR′), R′ being a hydrocarbon radical preferably containing 1 to 15 carbon atoms, more preferably chosen from alkyls, alkoxyalkyls, cycloalkyls and aryls, in particular from C₁-C₈ alkyls, C₂-C₈ alkoxyalkyls, C₅-C₁₀ cycloalkyls and C₆-C₁₂ aryls.

According to a preferred embodiment of the invention, Z satisfies one of the following formulae:

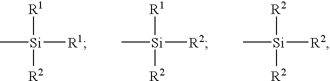

in which:
the radicals R¹, which are substituted or unsubstituted, identical or different, are chosen from the group consisting of C₁-C₈ alkyls, C₅-C₈ cycloalkyls and C₆-C₁₂ aryls; and
the radicals R², which are substituted or unsubstituted, identical or different, are chosen from the group consisting of hydroxyl, C₁-C₈ alkoxyls and C₅-C₈ cycloalkoxyls.

More preferably, in these formulae:
the radicals R¹ are chosen from the group consisting of C₁-C₄ alkyls, cyclohexyl and phenyl, especially C₁-C₄ alkyls and more particularly methyl and ethyl; and
the radicals R² are chosen from the group consisting of hydroxyl and C₁-C₆ alkoxyls, especially from hydroxyl and C₁-C₄ alkoxyls and more particularly from hydroxyl, methoxyl and ethoxyl.

Even more preferably, one of the radicals R¹ are chosen from methyl and ethyl and the radicals R² are chosen from hydroxyl, methoxyl and ethoxyl.

Preferably, the PVAr is a styrene homopolymer, especially a polystyrene, or a copolymer deriving from styrene units with a predominant weight fraction (preferably at least 50% or higher, more preferably 70% or higher), for example a styrene homopolymer, a styrene-DVB copolymer or a styrene-EVB copolymer or an EVB-DVB copolymer or a styrene-EVB-DVB copolymer, it being possible for the minor fraction (preferably less than 50%, more preferably less than 30%) of said copolymer to furthermore include another comonomer.

For clarity of the presentation, the reader is reminded below of the formulae for the styrene compounds EVB and DVB, and their comparison with styrene:

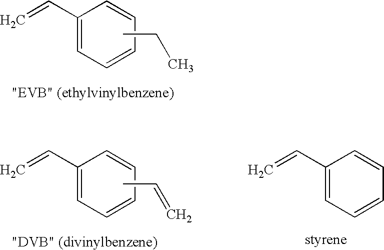

The functionalization of the PVAr is provided here by at least one initial comonomer (comonomer B) carrying the function Z. The molar content of this comonomer B is preferably greater than 5%, especially between 5 and 30% and in particular between 5 and 20%.

Comonomer A is preferably a styrene comonomer, more preferably chosen from the group consisting of styrene, EVB, DVB and mixtures of such monomers.

According to a first preferred embodiment, comonomer B is chosen from the group consisting of hydroxysilyl-(C₁-C₄)alkyl acrylates and methacrylates, (C₁-C₄)alkoxysilyl(C₁-C₄)alkyl acrylates and methacrylates, and mixtures of such monomers. More preferably, it is chosen from the group consisting of hydroxysilyl(C₁-C₄)alkyl, methoxysilyl(C₁-C₄)alkyl and ethoxysilyl(C₁-C₄)alkyl acrylates and methacrylates, and mixtures of such monomers, especially from hydroxysilylpropyl, methoxysilylpropyl and ethoxysilylpropyl acrylates and methacrylates, more particularly from trimethoxysilylpropyl acrylate and trimethoxysilylpropyl methacrylate.

According to a second preferred embodiment, comonomer B is chosen from the group consisting of styryl(C₁-C₄)alkylhydroxysilanes, styryl(C₁-C₄)alkyl(C₁-C₄)alkoxysilanes and mixtures of such monomers. More preferably, it is chosen from the group consisting of styryl(C₁-C₄)alkylhydroxysilane, styryl(C₁-C₄)alkylmethoxysilane and styryl(C₁-C₄)alkylethoxysilane, and mixtures of such monomers, especially styrylethylhydroxysilane, styrylethylmethoxysilane and styryletlhylethoxysilane. More particularly, styrylethyltrimethoxysilane (or trimethoxysilylethylstyrene) is used.

Given the preferred molar contents indicated above for this comonomer B carrying the functional group Z, said comonomer is used with a weight content that is preferably greater than 10%, more preferably between 10 and 30% and especially between 15 and 30%.

Comonomers of type B are well known, especially those chosen from the group consisting of trimethoxysilylpropyl methacrylate (abbreviated to MTSP), trimethoxysilylpropyl acrylate (ATSP) and trimethoxysilylethylstyrene (TSES) or styrylethyltrimethoxysilane, having respectively formulae:

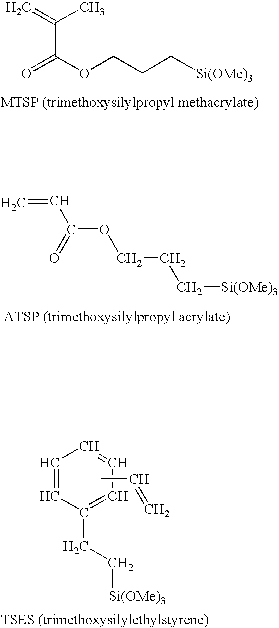

The functionalized PVAr is furthermore in a crosslinked state, that is to say in a three-dimensional form, so as to maintain the morphology of the filler at high temperature.

Such crosslinking is provided by at least one initial comonomer (comonomer C) that may be polymerized by an addition reaction and is difunctional, that is to say carrying at least a second functional group capable of creating a three-dimensional PVAr network upon polymerization. This “crosslinking” comonomer may be vinylaromatic (in this case identical to or different from comonomer A described above) or nonvinylaromatic.

More preferably suitable as comonomer C are comonomers carrying two unsaturated groups, especially ethylenic groups, which may polymerize by a radical route, in particular those chosen from the group consisting of di(meth)acrylates of polyols, especially of diols or triols (for example ethylene glycol, propylene glycol, 1,4-butanediol, 1,6-hexanediol and trimethylolpropane), alkylene di(meth)acrylamides (for example methylene bis-acrylamide), vinylaromatic compounds, preferably styrene compounds, which carry at least two vinyl groups (for example diisopropenylbenzene (DIB), divinylbenzene (DVB), trivinylbenzene (TVB)), and mixtures of such comonomers.

It is also possible to use as crosslinking comonomer the comonomer B carrying the aforementioned functional group Z, provided that, of course, this comonomer B is itself at least difunctional and copolymerizable, preferably by a radical route, with the other comonomers.

The weight content of crosslinking comonomer C is preferably greater than 1%, more preferably greater than 5% and in particular between 10 and 30%, especially if it is a vinylaromatic comonomer, in particular a styrene comonomer.

Various other monomers, such as for example diene monomers such as butadiene, isoprene and piperylene, may optionally be added in a minor amount, preferably less than 20% of the total weight of monomers.

The Z-functionalized and crosslinked PVAr may be prepared by any synthesis method suitable for functionalizing a vinylaromatic copolymer.

Preferably, this synthesis is carried out by radical polymerization of the various monomers. The general principle of such a technique is known and has in particular been applied to the radical emulsion polymerization of Z (alkoxysilane or hydroxysilane)-functionalized polystyrene in the presence of MTSP (see for example Macromolecules 2001, 34, 5737 and Macromolecules 2002, 35, 6185), or to the synthesis of crosslinked (but nonfunctionalized) polystyrene in the presence of DVB (Polymer 2000, 41, 481).

The polymers described in these publications are intended for applications as varied as paints, inks, magnetic fluids, paper and biotechnology. These documents neither describe nor suggest PVAr nanoparticles that are both functionalized and crosslinked, a copolymer of the aforementioned three comonomers A, B and C, having a very high reinforcing power since they are capable of fully reinforcing rubber matrices such as those used in tires.

Preferably, for the synthesis described above, vinylaromatic comonomer A is a styrene monomer chosen from the group consisting of styrene, EVB, DVB and mixtures of these monomers. Functionalizing comonomer B is preferably chosen from the group consisting of MTSP, ATSP, TSES and mixtures of these monomers. Crosslinking comonomer C is itself a styrene compound preferably chosen from the group consisting of DIB, DVB, TVB and mixtures of these monomers.

Thus, it is possible to obtain Z-functionalized and crosslinked PVAr nanoparticles in emulsion in water, that is to say in the form of a latex (typically, for example, 100 g of polymer per liter of water). It should be recalled that the term “polymer latex” should be understood in a known manner as a colloid system composed of a suspension or emulsion of polymer particles in an aqueous medium.

As reproduced in FIG. 1, these PVAr nanoparticles, characterized by TEM as explained in the above section I-1-A, are preferably in a substantially spherical shape (and therefore the shape of nanobeads), either in the isolated state or in aggregates, which are themselves possibly agglomerated. The number of nanoparticles per aggregate is typically between 2 and 100.

The mean diameter of these nanobeads, which may be measured by TEM as indicated in section I-1-A, is preferably between 10 and 100 nm, more preferably between 10 and 60 nm, and particularly between 10 and 40 nm.

The abovementioned PVAr nanoparticles according to the invention may be advantageously used for reinforcing polymeric matrices, it being possible for the polymer of these matrices to be of any kind, for example a thermoplastic, a thermoset or a diene or non-diene elastomer.

In these polymeric matrices, the PVAr nanoparticle content is preferably between 10 and 100 parts by weight per one hundred parts of polymer. Thanks to the low density of the filler, this content is advantageously between 10 and 80 phr, even more preferably between 20 and 50 phr.

Preferably, the PVAr filler furthermore constitutes more than 80%, more preferably more than 90% (by volume) of the total content of reinforcing filler, it being possible for a minor fraction (preferably less than 20%, more preferably less than 10% by volume) of this total content to consist of another reinforcing filler, for example an inorganic filler or carbon black.

Advantageously, the entire content of reinforcing filler is made up of the PVAr nanoparticles.

### II-2. PVAr Nanoparticle Masterbatch

The PVAr nanoparticles described above may be incorporated into their polymer matrix by means of a masterbatch, that is to say these particles are precompounded with at least one polymer, in order to make their subsequent incorporation into the final polymer matrix easier.

The term “masterbatch” should be understood, as is known, to mean the compounding of at least one polymer (for example an elastomer) and a reinforcing filler, as precursor compound of the final polymer matrix, ready for use.

This masterbatch, comprising at least the nanoparticles according to the invention and a polymer, for example an elastomer or an elastomer blend, constitutes another subject of the present invention.

This masterbatch may be prepared by a method that is itself another subject of the invention, such a method comprising the following steps:
a polymer latex and a functionalized and crosslinked PVAr latex are initially obtained;
the latices are intimately blended;
the blend thus obtained is precipitated; and
the precipitate thus obtained is then washed and dried.

The polymer latex may consist of a polymer already available as an emulsion, or for example of a polymer initially in solution which is emulsified in a mixture of an organic solvent and water, generally by means of a surfactant (the organic solvent disappearing at coagulation or precipitation).

The operation of intimately blending the two latices is carried out so as to properly disperse the PVAr nanoparticles in the polymer and to homogenize the system in order to form a latex blend having a solids concentration preferably between 20 and 500 g/l, more preferably between 50 and 350 g/l. Preferably, the two starting latices are diluted with water before being blended (for example 1 volume of water per 1 volume of latex).

The blend of the two latices may be precipitated by any method known to those skilled in the art, for example by mechanical action or preferably by the action of a coagulant.

The coagulant is any liquid compound that is miscible with water but not a solvent (or is a poor solvent) for the polymer, for example an aqueous saline solution, preferably an alcohol or a solvent mixture containing at least one alcohol (for example alcohol and water, or alcohol and toluene). More preferably, the coagulant is just an alcohol, such as methanol or isopropanol.

The coagulation is preferably carried out with stirring, at room temperature, in a large volume of coagulant. Typically, substantially the same volume of alcohol as the total volume of the two diluted latices is used. During this step it is preferred to pour the blend of the two latices onto the coagulant, and not the other way round.

After washing and drying, the masterbatch is obtained in a form called “polymer crumb”, comprising at least the chosen polymer and the PVAr nanoparticles embedded in the polymer matrix.

Optionally, various additives may be incorporated into the masterbatch, whether these be intended for the masterbatch proper (for example a stabilizer, carbon black as coloring and anti-UV agent, a plasticizer, an antioxidant, etc.) or for the final polymer matrix for which the masterbatch is intended.

The polymer of the masterbatch may be any polymer, which may or may not be the same as that (or those) of the final polymer matrix. It may be advantageous to use the same polymer and to adjust the PVAr content in the masterbatch to the final content intended, so as not to have to add polymer subsequently, during the production of the final polymer composition comprising the nanoparticles of the invention and the polymer thus reinforced.

### II-3. Use of the PVAr Nanoparticles as Tire Reinforcing Filler

The nanoparticles according to the invention described above are preferably used for the reinforcement of tires or semi-finished products for tires, these semi-finished products being chosen especially from the group consisting of the following: treads; underlayers, for example intended to be placed beneath these treads; crown reinforcement plies; sidewalls; carcass reinforcement plies; beads; protectors; inner tubes; impermeable internal rubber compounds for tubeless tires; internal rubber compounds for reinforcing sidewalls; and other rubber compounds intended for supporting the load in the case of running with flat tires.

To manufacture such semi-finished products, other compositions are used that are based at least on one (i.e. at least one) diene elastomer, one (at least one) PVAr filler according to the invention and one (at least one) coupling agent for bonding between this PVAr filler and this diene elastomer.

The expression “based on” should be understood to mean a composition comprising the blend and/or the reaction product of the various base constituents used, it being possible for some of these constituents to react and/or to be intended to react together, at least partially, during the various phases in the production of the composition, or during its subsequent curing.

The term “elastomer” or “rubber” (the two terms being synonymous) of the “diene” type is understood to mean, as is known, an elastomer (i.e. a homopolymer or copolymer) at least partly resulting from diene monomers (monomers carrying two carbon-carbon double bonds, whether conjugated or not). The diene elastomer is preferably chosen from the group of highly unsaturated diene elastomers formed by polybutadienes (abbreviated as BR), polyisoprenes (IR), natural rubber (NR), butadiene copolymers, isoprene copolymers and blends of these elastomers.

According to one particular embodiment, the diene elastomer is predominantly (that is to say for more than 50 phr) an SBR, whether an SBR prepared in emulsion (E-SBR) or an SBR prepared in solution (S-SBR) or an SBR/BR, SBR/NR (or SBR/IR) or BR/NR (or BR/IR). cut (blend).

According to another particular embodiment, the diene elastomer is predominantly (for more than 50 phr) an isoprene elastomer, that is to say an isoprene homopolymer or an isoprene copolymer chosen from the group consisting of natural rubber (NR), synthetic poyisoprenes (IR), various isoprene copolymers and blends of these elastomers. This isoprene elastomer is preferably natural rubber or a synthetic cis-1,4 polyisoprene having a content (mol %) of cis-1,4 bonds greater than 90%, more preferably still greater than 98%.

According to another particular embodiment, especially when the PVAr filler is intended for reinforcing a tire sidewall, an airtight internal rubber compound of a tubeless tire (or other airtight element), the rubber composition may contain at least one essentially saturated diene elastomer, in particular at least one EPDM copolymer or a butyl rubber (possibly chlorinated or brominated), whether these copolymers are used by themselves or blended with highly unsaturated diene elastomers, such as those mentioned above, especially NR or IR or BR or SBR.

The coupling agent (or bonding agent) is intended to establish a sufficient connection between the surface of the PVAr particles and the polymer for which these particles are intended, so that the said particles may fully fulfill their reinforcing filler function.

Coupling agents are well known to those skilled in the art and have been described in a very large number of documents. It is possible to use any coupling agent capable of effectively providing, in a diene rubber composition that may be used for the manufacture of tires, the bonding between a reinforcing inorganic filler, such as a silica, and a diene elastomer, particularly polyfunctional organosilanes or polyorganosiloxanes.

As examples of organosilanes, mention may be made of bis((C₁-C₄)alkoxy(C₁-C₄)silyl-(C₁-C₄)alkyl) polysulfides such as for example bis(3-trimethoxysilylpropyl) or bis(3-triethoxysilylpropyl) polysulfides, especially bis(3-triethoxysilylpropyl)tetrasulfide, abbreviated to TESPT, of formula [(C₂H₅O)₃Si(CH₂)₃ S₂]₂ or bis(triethoxysilylpropyl)disulfide, abbreviated to TESPD, of formula [(C₂H₅O)₃Si(CH₂)₃S]₂. Mention may also be made, as examples of advantageous coupling agents, of bis((C₁-C₄)monoalkoxyl(C₁-C₄)dialkyl(C₁-C₄)silylpropyl) polysulfides, more particularly bis(monoethoxydimethylsilylpropyl) tetrasulfide or bisulfide. As examples of coupling agents other than the aforementioned polysulfide alkoxysilanes, mention may especially be made of bifunctional polyorganosiloxanes or hydroxysilane polysulfides.

The coupling agent content is preferably less than 10 phr, more preferably less than 7 phr and in particular less than 5 phr.

Of course rubber compositions also include some or all of the standard additives conventionally used in elastomer compositions intended for the manufacture of tires, such as for example plasticizers and oil extenders, pigments, protective agents, such as antiozone waxes, chemical antiozonants, antioxidants, antifatigue agents, reinforcing or plasticizing resins, methylene acceptors or methylene donors, coupling activators, covering agents, processing aids, a crosslinking system based either on sulfur, or on sulfur donors and/or peroxides and/or bismaleimides, vulcanization accelerators and vulcanization activators.

### III. EXEMPLARY EMBODIMENTS

### III-1. Test 1

In the following exemplary embodiments, the PVAr filler, Z-functionalized and crosslinked, was synthesized by a radical polymerization of four different monomers, namely styrene, EVB, DVB and MTSP, and then incorporated into a rubber composition for tires in the form of a masterbatch obtained by coprecipitating a latex of the PVAr filler and a latex of a diene elastomer (SBR).

According to one particularly preferred embodiment, the weight content of comonomer B carrying the functional group Z, (here, MTSP) was between 20 and 30%, that of the crosslinking comonomer C (here, DVB) was between 10% and 30% and the total weight fraction of styrenic units (i.e., in the present case, EVB and DVB) was greater than 70%.

III-1-A. Synthesis of the PVAr Nanoparticles

The radical emulsion polymerization was carried out in a medium buffered to a pH of 7, with simultaneous introduction, into a reactor, of the styrene, the MTSP (Aldrich product), and a DVB/EVB blend (a DVB product from Fluka containing in fact 50% DVB and 50% isomers of EVB), said blend being washed beforehand three times with an aqueous 1M sodium hydroxide solution (3×165 ml per 200 ml of DVB/EVB blend) and then washed with water until a neutral pH was reached.

The various monomers were subjected beforehand to nitrogen sparging, as were the aqueous solutions used, with the exception of the SDS solution (sparging in the powder state). The reaction was carried out in a 1.5-liter reactor fitted with mechanical stirring and a condenser. After introducing 845 ml of water and sparging with nitrogen for 30 minutes with stirring, 50 ml of an aqueous 0.9 mol/l sodium dodecylsulfate (SDS) solution, as surfactant, and 50 ml of an equimolar 1 mol/l buffer solution of sodium hydrogen phosphate and ammonium dihydrogen phosphate were introduced in succession. Added to this solution buffered to pH 7, and slowly stirred at 150 rpm and heated at 60° C., was the monomer charge composed of 36.4 g of styrene (i.e. a weight fraction of 37%), 24.8 g of MTSP (weight fraction of 25%), 18.7 g of DVB (weight fraction of 19%) and 18.7 g of EVB (weight fraction of 19%), giving a total of 98.6 g of monomers.

Then added to the resulting emulsion, with vigorous stirring (350 rpm), were 36 ml of an aqueous (0.125 mol/l) potassium persulfate solution. After stirring for 2 h 45 min at 60° C., 18 ml of an aqueous (0.5 mol/l) hydroquinone solution were added to the polymerization medium. The reaction medium was cooled before being mixed with the elastomer (conversion, measured as solids content, was 95%).

The functionalized and crosslinked PVAr thus obtained was in the form of a latex comprising about 10% by weight of solid (PVAr), the balance (about 90%) consisting of water.

The filler latex was characterized as indicated in section I-1-A. The TEM micrograph in FIG. 1 shows that the nanoparticles (elementary particles) of the invention are in this case in the form of nanobeads having predominantly a diameter between 20 and 60 nm. The average circular diameter was 30 nm (with a standard deviation of 6 nm).

At this stage, the PVAr was isolated and dried for determining its degree of functionalization (with Z) provided by the MTSP monomer, by assaying the silicon content, the procedure being as follows:
first step of dissolving the specimen in an aqueous medium followed by calcination and then by alkaline fusion of the ash obtained;
a second step, quantitatively assaying the silicon by inductively coupled plasma atomic emission spectroscopy (ICP/AES).

More precisely, the procedure was the following: the specimen was calcined at 525° C. for 2 hours. The fusion operation was then performed on the ash obtained, at 1150° C. (±50° C.) with lithium tetraborate (for example 2 g per 1 g of calcined filler), for about 25 minutes. After cooling, the entire fused mass obtained was dissolved at 80° C. in hydrochloric acid diluted to 2% in water. The solution was then transferred and adjusted in a calibrated flask.

The silicon assay was then carried out, on the contents of the calibrated flask, by ICP/AES. The aqueous solution was sent into an argon plasma via an injection system, where it underwent desolvation, atomization and then excitation/ionization of the atoms present. The silicon emission line at 251.611 nm was then selected by means of a monochromator and then quantified by comparison with a calibration curve prepared from a certified standard solution of the corresponding element (the intensity I of the emitted line being proportional to the concentration C of the corresponding element).

The result was expressed as mass % of silicon relative to the dry specimen (predried at 105° C. for 2 hours) according to the formula:

% Si=C×V×(100/M)

in which:

C=Si concentration expressed in mg/l;

V=volume of the calibrated flask in l;

M=mass of the specimen in mg.

The measured value was compared with that of a poly(styrene-DVB-EVB) control synthesized in the identical manner, but without MTSP.

The results below clearly demonstrate that the silicon present in the PVAr filler is clearly due to the functionalization of the PVAr provided by the MTSP monomer:

| Si content (±0.2%) | without MTSP | with MTSP |
|---|---|---|
| Assayed (%) | not detected | 2.9% |

The resulting powder was also analyzed by ²⁹Si NMR(CPMAS mode, 200 MHz AV spectrometer; 4 kHz rotation speed). The analysis revealed a predominant feature between −41 and −38 ppm, characteristic of silicon of the Si—X type, as described above.

The density of the nanoparticles was measured on the powder using a helium pycnometer, the value obtained being 1.1 g/cm³.

III-1-B. Preparation of the Masterbatch

The PVAr latex was then incorporated directly into an SBR diene elastomer for obtaining a masterbatch, as indicated in section II-2 above. The intended PVAr filler content in the masterbatch, as in the intended final rubber composition, was 39 phr (parts by weight per 100 parts of elastomer).

The SBR latex was prepared in a manner know Ito those skilled in the art, under the following conditions: polymerization temperature: 5° C.; surfactant: sodium dodecylsulfate; initiator: iron^{II} salt/hydroperoxide redox system. The conversion was around 50 to 60%. The SBR thus produced had the following characteristics: inherent viscosity at 0.1 g/dl in toluene at 25° C.: 3.11; Mooney viscosity (MS) equal to 67; T_{g} (DSC)=−52° C.; microstructure: 23.6% styrene, butadiene phase: 15.0% vinyl, 70.1% trans and 14.9% cis.

The solids content of the SBR latex was determined by weighing, on the dry extract, before preparing the masterbatch. The SBR latex was diluted three times with water, i.e. 734 ml of 216.6 g/l SBR latex (159 g of SBR) and 1468 ml of dilution water.

After the PVAr filler latex had been synthesized, it was cooled to room temperature and then added to the SBR latex diluted to an amount corresponding to 39 phr of filler, i.e. 743 ml of 83.4 g/l PVAr filler latex (62 g of filler). The resulting mixture was gently homogenized. The mixture was then added, at a rate of 100 ml/min, to 6000 ml of methanol stirred at 350 rpm. The precipitate thus obtained was filtered on a filter paper, rinsed with water until little constant residual foaming of the washing water and a negative silver nitrate test of the washing water were obtained. The precipitate thus washed was dried at a reduced pressure in nitrogen at 60° C. for 3 to 4 days, after which 212 g of dry masterbatch were thus recovered.

III-1-C. Preparation of the Rubber Compositions

A control composition (with HDS silica filler) was conventionally prepared as follows: the SBR elastomer pre-extended with 37.5 phr of an aromatic oil, and also part of the filler, were firstly introduced (the “non-productive step”) into an internal mixer, the initial chamber temperature of which was about 90° C. After an appropriate kneading time, of the order of 1 minute, the coupling agent and the remaining part of the filler were added. The other ingredients, with the exception of the vulcanization system, were added after 2 minutes. The internal mixer was then 75% full. The mixture then underwent thermomechanical working for a time of about 6 minutes, with an average speed of the blades of 70 rpm, until a drop temperature of about 135° C. was obtained.

The procedure for a second composition, this time incorporating the PVAr filler according to the invention, was carried out in the identical manner, except that the PVAr filler and the diene elastomer were introduced in one go right at the start, in the form of the masterbatch prepared beforehand, containing 39 phr PVAr particles. The oil extender was then gradually incorporated.

After the thermomechanical mixing work, the compound obtained was recovered, cooled and then the vulcanization system (sulfenamide-type primary accelerator and sulfur) was added to it on an external mixer at 30° C., all the ingredients being mixed (in the “productive step”) for a suitable time (between 5 and 12 minutes).

The compositions thus obtained were then either calendered in the form of rubber sheets (2 to 3 mm in thickness), for measuring their mechanical properties, or extruded in the form of a semi-finished product for a tire, for example a tread. The vulcanization (curing) was carried out under pressure at 150° C. for 40 minutes.

The TEM micrograph (produced as indicated in section I-1-B) shown in FIG. 2 was that obtained on the composition comprising the nanoparticles of the invention. It shows that the PVAr filler is in the form of spherical elementary particles (nanobeads) assembled in aggregates uniformly dispersed in the elastomeric phase.

III-1-D. Characterization of the Rubber Compositions

The rubber compositions were characterized, before and alter curing, as indicated below.

Tensile Tests

These tests were used to determine the elastic stresses and properties at break after curing. Unless otherwise indicated, they were carried out in accordance with French standard NF T 46-002 of September 1988. The measurements made, at first elongation (i.e. with no accommodation cycle) were the true secant moduli (i.e. calculated with respect to the real cross section of the test piece), expressed in MPa, at 100% elongation (modulus M100) at 300% elongation (modulus M300), at 400% elongation (modulus M400) and even 600% elongation (M600 modulus).

Also measured were the tensile strengths (in MPa) and the elongations at break (in %). All these tensile measurements were carried out under standard temperature and moisture conditions (23±2° C.; 50±50% relative humidity).

Processing of the tensile recordings also allowed the curve of modulus as a function of elongation to be plotted (see appended FIG. 3 to FIG. 5), the modulus used here being the true secant modulus measured at first elongation.

Rheometry:

The measurements were made at 150° C. with an oscillating-chamber rheometer according to the DIN 53529—part 3 (June 1983) standard. The variation of the rheometric torque as a function of time describes the variation of the stiffness of the composition as a result of the vulcanization reaction. The measurements were processed according to the DIN 53529—part 2 (March 1983) standard. Tᵢ (in minutes) is the induction time, that is to say the time needed before the onset of the vulcanization reaction. The 1-order rate of conversion constant K (in min⁻¹) was also measured, calculated between 300% and 80% conversion. This allows the vulcanization rate to be determined (the higher K, the more rapid the rate).

Dynamic Properties:

The dynamic properties ΔG* and tan δₘₐₓ were measured on a viscoanalyzer (Metravib VA4000), according to the ASTM D 5992-96 standard. The response of a specimen of vulcanized composition (cylindrical test piece 2 mm in thickness and 79 mm² in cross section), subjected to a sinusoidal stress in simple alternating shear at a frequency of 10 Hz, under standard temperature conditions (23° C.) according to the ASTM D 1349-99 standard was recorded. A scan with a peak-to-peak strain amplitude ranging from 0.1 to 50% (forward cycle) and then from 50% to 0.10% (return cycle) was carried out. The results exploited were the complex dynamic shear modulus (G*) and the loss factor tan δ. For the return cycle, the maximum value of tan δ observed (tan δₘₐₓ) and the difference in complex modulus (ΔG*) between the 0.1 and 50% strain values (the Payne effect) were indicated.

III-1-E. Results of the Comparative Rubber Tests

The object of test 1 was to compare the performance of the nanoparticles of the invention to those of the conventional inorganic filler (HDS silica).

To do this, two compositions (prepared according to section III-1-C above), the general formulation of which was conventional in the case of high-performance tire treads, combining low rolling resistance and high wear resistance (low-energy-consumption automobile tires called “green tires”), were compared. The HDS silica chosen for reinforcing the control composition was a tire-grade silica having, in a known manner, a very high reinforcing power (Zeosil 1165 MP from Rhodia, with a density of about 2.1 g/cm³.).

For the control composition, the diene elastomer used was SBR, the synthesis of which was described in the above section III-2, extended beforehand with 37.5% of an aromatic oil (i.e. 37.5 phr of oil per 100 phr of dry SBR).

The two compositions tested were strictly identical apart from the nature of the reinforcing filler:
composition C-1: HDS silica (control);
composition C-2: MTSP-functionalized PVAr (invention).

The reinforcing filler content was adjusted to iso-volume fraction of filler (the same volume, i.e. 19%, of filler in each composition). Since the specific surface area of the polymeric filler was lower, the amount of TESPT coupling agent introduced into composition C-2 was therefore smaller.

In composition C-2 (invention), the PVAr nanoparticles represented about 97% (by volume) of the entire content of reinforcing filler, this including a small portion (2 phr) of carbon black.

Tables 1 and 2 give in succession the formulation of the various compositions (Table 1: content of the various ingredients expressed in phr) and their properties before and after curing at 150° C. for 40 min (Table 2). FIG. 3 reproduces the curves of the true secant modulus (in MPa) as a function of the elongation (in %). These curves are marked C1 and C2 and correspond to rubber compositions C-1 and C-2 respectively.

Examination of the various results in Table 2 shows, for the composition reinforced with the nanoparticles according to the invention, compared with the control composition C-1:
in the uncured state, the scorch safety time (Tᵢ) and the rate of vulcanization (constant K) are slightly improved;
a very substantial reduction in the density (measured using a helium pycnometer) of about 16% compared with the control composition (the difference being maintained, of course, after curing);
after curing, higher modulus values at high strain (M300 and M400), a clear indicator to a person skilled in the art of a very high level of reinforcement, at least equal to that provided by the HDS control silica; and
finally, something which is not insignificant, hysteresis properties which, unexpectedly, are very substantially improved, as illustrated by a large reduction in the tan δₘₐₓ and ΔG* values. This is a recognized indicator of reduced rolling resistance and reduced heat built-up.

The appended FIG. 3 clearly confirms the above results: it should be noted that curve C2 lies appreciably above curve C1, the difference becoming more pronounced when the elongation increases. This illustrates a high level of reinforcement, at least equal to that provided by the HDS silica, in other words a high quality of bonding or coupling between the functionalized PVAr and the diene elastomer.

### III-2. Test 2

In the following exemplary embodiments, three functionalized and crosslinked PVAr polymeric fillers (denoted by filler A, filler B and filler C respectively) were synthesized by radical polymerization of the four different monomers:
filler A: styrene, EVB, DVB and MTSP (trimethoxysilylpropyl methacrylate);
filler B: styrene, EVB, DVB and TSES (styrylethyltrimethoxysilane); and
filler C: styrene, EVB, DVB and HEMA (hydroxyethyl methacrylate).

Only fillers A and B therefore carried a functional group Z of formula ≡Si —X (X representing a hydroxyl or hydrolyzable group) and were therefore in accordance with the invention.

It will be recalled that hydroxyethyl methacrylate (HEMA) has the following formula:

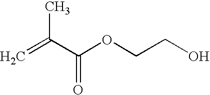

This monomer was used in particular as functionalizing comonomer in the synthesis of certain polymeric fillers as described, for example, in the patent documents EP-A-1 063 259 or US-B-6 399 706.

As previously in Test 1, to be tested and compared, these three fillers were then incorporated into rubber compositions in the form of a masterbatch obtained by coprecipitating a latex of the PVAr filler and a latex of a diene elastomer (SBR).

III-2-A. Synthesis of the PVAr Fillers

The radical emulsion polymerization was carried out in a medium buffered to pH 7, with simultaneous introduction, into a reactor, of styrene, depending on the intended functionalization, of MTSP (filler A), of TSES (filler B) or of HEMA (filler C), and of a DVB/EVB blend (a DVB product from Fluka containing in fact 50% DVB and 50% EVB isomers). Said blend was washed beforehand three times with an aqueous 1M sodium hydroxide solution (3×165 ml per 200 ml pf DVB/EVB blend) and then washed with water until a neutral pH was obtained.

The various monomers were subjected beforehand to nitrogen sparging, as were the aqueous solutions used, with the exception of the SDS solution (sparging in the powder state). The HEMA was distilled beforehand. The reaction was carried out in a 1.5-liter reactor fitted with mechanical stirring and with a condenser. After introducing 845 ml of water, or 773 ml of water in the case of TSES, and nitrogen sparging for 30 min with stirring, 50 ml of an aqueous 0.9 mol/l SDS solution and 50 ml of an equimolar 1 mol/l buffer solution of sodium hydrogen phosphate and ammonium dihydrogen phosphate were introduced in succession.

The monomer fillers were added to this solution buffered to pH 7 gently stirred at 150 rpm and heated at 60° C., as follows:
filler A: consisting of 36.4 g of styrene (i.e. a weight fraction of 37%), 24.8 g of MTSP (weight fraction of 25%), 18.7 g of DVB (weight fraction of 19%) and 18.7 g of EVB (weight fraction of 19%), giving a total of 98.6 g of monomers;
filler B: consisting of 36.4 g of styrene (i.e. a weight fraction of 36%), 26.9 g of TSES (weight fraction of 26.7%), 18.7 g of DVB (weight fraction of 18.6%) and 18.7 g of EVB (weight fraction of 18.6%), giving a total of 100.7 g of monomers; and
filler C: consisting of 36.4 g of styrene (i.e. a weight fraction of 42%), 13.1 g of HEMA (weight fraction of 15.1%), l 8.7 g of DVB (weight fraction of 21.5%) and 18.7 g of EVB (weight fraction of 21.5%), giving a total of 86.9 g of monomers.

Next, 36 ml of an aqueous (0.125 mol/l) potassium persulfate solution were added to the resulting emulsion, with vigorous stirring (350 rpm). Since the TSES was stabilized with TBC (4-tert-butylcatechol), the amount of solution introduced in the case of the latter was 108 ml. After stirring for 2 h 45 min at 60° C., 18 ml of an aqueous (0.5 mol/l) hydroquinone solution were added to the polymerization medium. The reaction medium was cooled before it was mixed with the elastomer (conversion, measured by solids content, was 95%).

The functionalized and crosslinked PVAr fillers thus obtained were in the form of a latex comprising about 10% by weight of polymer, the balance (about 90%) being water. The assay of the silicon content on fillers A and B, carried out as indicated previously in Test 1, clearly confirmed the functionalization provided by the MTSP and TSES monomers (silicon content of about 2.7 to 2.9%). For these fillers A and B, the NMR analysis clearly confirmed the presence of a predominant feature between −41 ppm and -38 ppm, characteristic of silicon of Si—X type.

III-2-B. Preparation of the Masterbatch

As soon as the filler latices had been synthesized, they were cooled to room temperature and then added, each time, to the SBR latex (diluted to 216.6 g/l) prepared as indicated previously in Test 1 (section III-1-B), in order to obtain a masterbatch. As previously, the intended PVAr filler content in the masterbatch, as in the final rubber composition, was 39 phr.

III-2-C. Preparation of the Rubber Compositions

The polymeric filler and the diene elastomer, in the form of the masterbatch prepared beforehand, containing 39 phr of PVAr particles, were firstly introduced, in one go (“non-productive step”), into an internal mixer, the initial chamber temperature of which was about 90° C. After kneading for an appropriate time, of the order of 1 minute, the coupling agent was added and then the oil extender was gradually incorporated. The other ingredients, with the exception of the vulcanization system, were added after 2 minutes. The internal mixer was then 75% full. The mixture then underwent thermomechanical working for a time of about 6 minutes, with an average speed of the blades of 70 rpm, until a drop temperature of about 135° C. was obtained.

After the thermomechanical mixing work, the compound obtained was recovered, cooled and then the vulcanization system (sulfenamide-type primary accelerator and sulfur) was added on an external mixer at 30° C., all the ingredients being mixed (“productive step”) for an appropriate time (between 5 and 12 minutes). The compositions thus obtained were either calendered in the form of rubber sheets (with a thickness of 2 to 3 mm), for measuring their mechanical properties, or extruded in the form of a semi-finished product for a tire, for example a tread. The vulcanization (curing) was carried out under pressure at 150° C. for 40 minutes.

III-2-D. Comparative Rubber Test

The purpose of this test was to compare, as rubber composition, the performance of the nanoparticles of the invention (fillers A and B) with the performance of the control polymeric filler (filler C). Three compositions (denoted by C-3, C-4 and C-5 respectively) incorporating fillers A, B and C were prepared according to section III-2-C above. These three compositions were for example intended for tire treads.

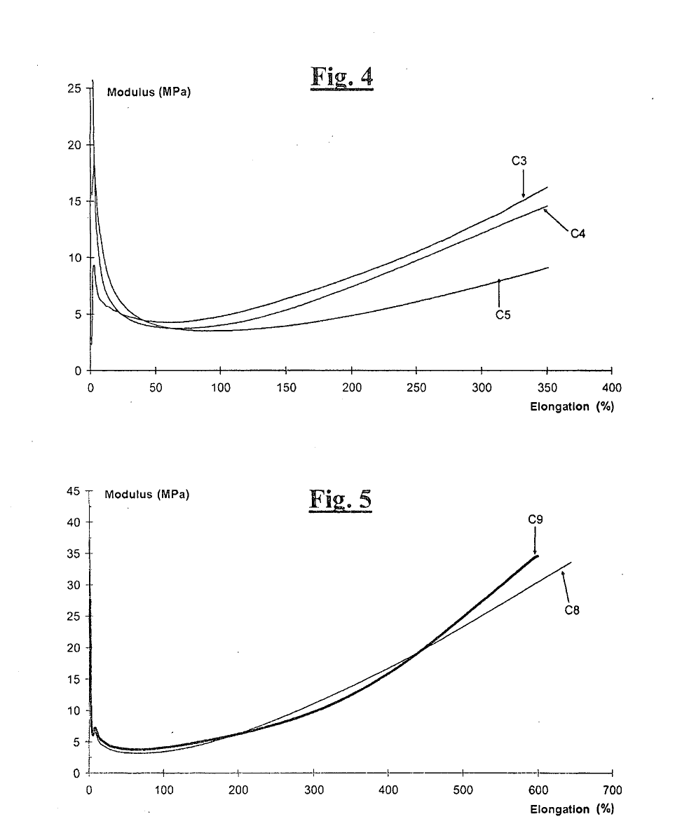

Tables 3 and 4 give in succession the formulation of the various compositions (Table 3: contents of the various ingredients expressed in phr) and their properties before and after curing at 150° C. for 40 minutes (Table 4). In the three compositions, the functionalized PVAr filler represents about 97% (by volume) of all the reinforcing filler, the latter furthermore including a very small proportion (2 phr) of carbon black. FIG. 4 reproduces the curves of the true secant modulus (in MPa) as a function of the elongation (in %). These curves are denoted by C3, C4 and C5 and correspond to rubber compositions C-3, C-4 and C-5 respectively.

Examination of the results in Table 4 show, for the two compositions C-3 and C-4 reinforced with the nanoparticles according to the invention, compared with composition C-5 using the control filler:
an identical density;
after curing, markedly higher high-strain modulus values (M100 and M300), a clear indicator of a greater level of reinforcement provided by fillers A and B. Appended FIG. 4 clearly confirms the above results, curves C3 and C4 being well above curve C5, with a difference that increases as the elongation increases; and
finally, and above all, hysteresis values (illustrated by tan δₘₐₓ and ΔG*) which are maintained at the remarkably low level of composition C-1 above and very much below the values observed in composition C-5. This presages a rolling resistance and a heat built-up that are substantially reduced thanks to the use of polymeric fillers A and B.

### III-3. Test 3

In this test, a new Z-functionalized and crosslinked PVAr filler was synthesized as described above in Test 1, but on a larger scale. It was then incorporated into a rubber composition in the form of a masterbatch obtained by coprecipitating a PVAr filler latex and a natural rubber (NR) latex. Said composition using the nanoparticles according to the invention was finally compared with a control rubber composition based on NR and conventionally filled with HDS silica.

III-3-A. Synthesis of the PVAr Filler

As in the previous tests, the radical emulsion polymerization was carried out in a buffered medium (pH equal to 7) with simultaneous introduction, into a reactor, of styrene, MTSP (Aldrich product) and a DVB/EVB blend (DVB product from Fluka), said blend having been washed beforehand three times with a 1M aqueous sodium hydroxide solution and then washed with water until a neutral pH was obtained.

The various monomers were subjected beforehand to nitrogen sparging, as were the aqueous solutions used, with the exception of the SDS solution (sparging in the powder state). The reaction was carried out in a 30-liter reactor fitted with mechanical stirring. After introducing 16.3 l of water and sparging with nitrogen for 30 minutes with stirring, the temperature was raised to 60° C. Next, 965 ml of an aqueous 0.9 mol/l SDS solution and 965 ml of an equimolar 1 mol/l buffer solution of sodium hydrogen phosphate and ammonium dihydrogen phosphate were introduced in succession. Added to this solution, buffered to pH 7, gently stirred at 150 rpm and heated to 60° C., was the monomer filler composed of 701 g of styrene (i.e. a weight fraction of 37%), 478 g of MTSP (weight fraction of 25%), 361.5 g of DVB (weak fraction of 19%) and 361.5 g of EVB (weight fraction of 19%), giving a total of 1902 g of monomers.

Next, 695 ml of an aqueous potassium persulfate (0.125 mol/l) solution were added to the resulting emulsion, with vigorous stirring (350 rpm). After stirring for 2 h 45 min at 60° C., 345 ml of an aqueous hydroquinone (0.5 mol/l) solution were added to the polymerization mixture. The reaction medium was cooled and diluted with 42 l of water before being mixed with the elastomer latex, i.e. 63.3 l of 28.5 g/l Z-functionalized PVAr filler latex (1807 g of filler).

The physicochemical characteristics of the filler latex thus prepared were substantially the same as those found for the product synthesized on a smaller scale (Test 1). In particular, analysis showed that the nanoparticles (elementary particles) of the invention were in the form of nanobeads having predominantly a diameter between 20 and 60 nm (average circular diameter about 30 nm). The density of the filler, measured on powder, was 1.1 g/cm³.

III-3-B. Preparation of the Masterbatch

The PVAr filler latex was incorporated into natural rubber in order to obtain a masterbatch. The intended PVAr filler content in the masterbatch, as in the final rubber composition, was 39 phr. The solids content of the NR latex was determined by weighing, on the dry extract. Before preparing the masterbatch, the NR latex was diluted with water to an NR content of 200 g/l.

The PVAr filler latex diluted and cooled to room temperature was added to the diluted NR latex in an amount of 39 phr of filler (i.e. 23 l of 200 g/l NR latex). Next, 64 g of antioxidant (N-(1,3-dimethylbutyl)-N′-phenyl-p-phenylenediamine) were added in the form of an aqueous emulsion and the resulting mixture was gently homogenized. This mixture was then added at a rate of 2 l/min to 168 l of vigorously stirred methanol, in order to precipitate the masterbatch.

The precipitate thus obtained was filtered and rinsed with water, and then the methanol was removed by steam distillation. The masterbatch was then washed with water to remove the surfactant and buffer salts by several cycles of successive dilution and settling operations until a little constant residual foaming of the washing water and a negative silver nitrate test of the washing water were obtained. The masterbatch thus washed was filtered and then dried under reduced pressure (in nitrogen) at 60° C. for 2 days.

III-3-C. Rubber Tests

Two NR rubber compositions were then prepared as indicated above in the case of Test 1 (top temperature about 145° C.), these two compositions differing only by the nature of their reinforcing filler, as follows:
composition C-6 HDS silica (control);
composition C-7 MTSP-functionalized PVAr (invention).

As application examples, such rubber compositions may typically be used in parts of ground-contacting systems, particularly tires, normally using NR-based rubber matrixes, such as for example the internal safety supports for tires, the sidewalls, the tire bead zones, the tread sublayers, and also the treads for these tires, especially for heavy-goods vehicles.

The content of reinforcing filler was adjusted to iso-volume fraction of filler (same volume, i.e. about 17%, of filler in each composition). Since the specific surface area of the polymeric filler was lower, the amount of TESPT coupling agent introduced into composition C-7 was therefore appreciably lower. In composition C-7 of the invention, the PVAr filler represents about 97% (by volume) of all the reinforcing filler, the latter including a small proportion (1 phr) of carbon black.

Tables 5 and 6 give, in succession, the formulation of the various compositions (Table 5: content of the various ingredients expressed in phr) and their properties before and after curing at 150° C. for 30 minutes (Table 6). FIG. 5 reproduces the curves of the true secant modulus (in MPa) as a function of the elongation (in %). These curves are denoted by C6 and C7 and correspond to compositions C-6 and C-7 respectively.

Examination of the various results in Table 6 shows, for the composition (C-7) prepared according to the invention, compared with the control composition (C-6):
in the uncured state, similar or even improved scorch safety time (Tᵢ) and vulcanization rate (constant K);
a very substantial reduction in density (about −14%);
after curing, higher very-high-strain modulus values (see the M600 values). Appended FIG. 5 clearly confirms the above results, which shows that curve C7 lies well above curve C6 for the highest strains, the difference between the two curves increasing as the elongation increases. This illustrates a high level of reinforcement provided by the PVAr filler, at least equal to if not greater than that provided by the HDS silica as control; and
finally and above all, and this clearly confirms all the above results observed with a synthetic diene elastomer (SBR), hysteresis properties this time are again greatly improved (very substantially reduced tan δₘₐₓ and ΔG* values).

In conclusion, the PVAr nanoparticles according to the invention, thanks to their very greatly reduced density compared with a conventional reinforcing filler such as carbon black or HDS silica, makes it possible for the weight of the polymeric compositions to be very substantially reduced.

This objective is achieved not only without degrading the reinforcement, synonymous with wear resistance or tear resistance, compared with these conventional fillers, but also by allowing an appreciable reduction in hysteresis to be achieved, synonymous with rolling resistance or heat built-up, further improved relative to a conventional inorganic reinforcing filler such as an HDS silica.

Finally, one remarkable advantage of the PVAr filler should be emphasized: since the density of the polymeric matrix becomes substantially equal to that of the PVAr filler itself, it thus becomes possible to increase the reinforcing filler content without increasing the density of said polymeric matrix.

Advantageously, the nanoparticles of the invention may be used as reinforcing filler in any type of polymeric matrix, whether the polymers be in particular thermoplastics, thermosets or elastomers (as examples: polyamides, polyesters, polyolefines, such as polypropylene, polyethylene, PVC, polycarbonates, polyacrylics, epoxy resins, polysiloxanes, polyurethanes, diene elastomers).

TABLE 1

| Composition No.: | C-1 | C-2 |
|---|---|---|
| SBR (1) | 100 | 100 |
| HDS silica (2) | 77 | — |
| PVAr filler (3) | — | 39 |
| Coupling agent (4) | 6.2 | 1.8 |
| Carbon black (N234) | 2 | 2 |
| Aromatic oil (5) | 37.5 | 37.5 |
| ZnO | 2.5 | 2.5 |
| Stearic acid | 2 | 2 |
| Antioxidant (6) | 1.9 | 1.9 |
| Sulfur | 1.5 | 1.5 |
| Accelerator (7) | 2.5 | 2.5 |

(1) SBR (synthesis described in section III-1-B);
(2) HDS silica (Zeosil 1165MP from Rhodia);
(3) MTSP-functionalized PVAr (synthesis according to section III-1);
(4) TESPT (Si69 from Degussa);
(5) Aromatic oil (Exarol MX 140 from Total);
(6) N-1,3-dimethylbutyl-N-phenylparaphenylenediamine (Santoflex 6-PPD from Flexsys);
(7) N-cyclohexyl-2-benzothiazylsulfenamide (Santocure CBS from Flexsys).

TABLE 2

| Composition No.: | C-1 | C-2 |
|---|---|---|
| Properties before curing: | | |
| Tᵢ (min) | 8 | 12 |
| K (min⁻¹) | 0.136 | 0.157 |
| Density (g/cm³) | 1.19 | 1.01 |
| Properties after curing: | | |
| M100 (MPa) | 3.7 | 4.8 |
| M300 (MPa) | 11.8 | 13.2 |
| M400 (MPa) | 17.2 | 19.8 |
| Tensile strength (MPa) | 23.3 | 22.0 |
| Elongation at break (%) | 601 | 484 |
| ΔG* | 6.2 | 1.6 |
| tanδₘₐₓ | 0.330 | 0.199 |

TABLE 3

| Composition No.: | C-3 | C-4 | C-5 |
|---|---|---|---|
| SBR (1) | 100 | 100 | 100 |
| PVAr filler (2) | 39 | — | — |
| PVAr filler (3) | — | 39 | — |
| PVAr filler (4) | — | — | 39 |
| Coupling agent (5) | 1.8 | 1.8 | 1.8 |
| Carbon black (N234) | 2 | 2 | 2 |
| Aromatic oil (6) | 37.5 | 37.5 | 37.5 |
| ZnO | 2.5 | 2.5 | 2.5 |
| Stearic acid | 2 | 2 | 2 |
| Antioxidant (7) | 1.9 | 1.9 | 1.9 |
| Sulfur | 1.5 | 1.5 | 1.5 |
| Accelerator (8) | 2.5 | 2.5 | 2.5 |

(1) SBR (synthesis described in section III-1-B);
(2) Filler A (MTSP-functionalized PVAr);
(3) Filler B (TSES-functionalized PVAr);
(4) Filler C (HEMA-functionalized PVAr);
(5) TESPT (Si69 from Degussa);
(6) Aromatic oil (Exarol MX 140 from Total);
(7) N-1,3-dimethylbutyl-N-phenylparaphenylenediamine (Santoflex 6-PPD from Flexsys);
(8) N-cyclohexyl-2-benzothiazylsulfenamide (Santocure CBS from Flexsys).

TABLE 4

| Composition No.: | C-3 | C-4 | C-5 |
|---|---|---|---|
| Density (g/cm³) | 1.01 | 1.01 | 1.01 |
| Properties after curing: | | | |
| M100 (MPa) | 4.8 | 4.0 | 3.5 |
| M300 (MPa) | 13.2 | 12.2 | 7.5 |
| ΔG* | 1.6 | 1.2 | 4.3 |
| tanδₘₐₓ | 0.199 | 0.197 | 0.291 |

TABLE 5

| Composition No.: | C-6 | C-7 |
|---|---|---|
| NR (1) | 100 | 100 |
| HDS silica (2) | 50 | — |
| PVAr filler (3) | — | 25.7 |
| Carbon black (N234) | 1 | 1 |
| Coupling agent (4) | 4 | 1.16 |
| ZnO | 3 | 3 |
| Stearic acid | 2.5 | 2.5 |
| Antioxidant (5) | 2.0 | 2.0 |
| Sulfur | 1.5 | 1.5 |
| Accelerator (6) | 1.8 | 1.8 |

(1) Natural rubber;
(2) HDS silica (Zeosil 1165MP from Rhodia);
(3) MTSP-functionalized PVAr;
(4) TESPT (Si69 from Degussa);
(5) N-1,3-dimethylbutyl-N-phenylparaphenylenediamine (Santoflex 6-PPD from Flexsys);
(6) N-cyclohexyl-2-benzothiazylsulfenamide (Santocure CBS from Flexsys).

TABLE 6

| Composition No.: | C-6 | C-7 |
|---|---|---|
| Properties before curing: | | |
| Tᵢ (min) | 9 | 10 |
| K (min⁻¹) | 0.307 | 0.381 |
| Density (g/cm³) | 1.15 | 0.99 |
| Properties after curing: | | |
| M100 (MPa) | 3.4 | 4.1 |
| M300 (MPa) | 11.1 | 9.8 |
| M400 (MPa) | 16.7 | 15.8 |
| M600 (MPa) | 30.4 | 34.6 |
| Tensile strength (MPa) | 29.2 | 29.6 |
| Elongation at break (%) | 644 | 600 |
| ΔG* | 1.92 | 0.83 |
| tanδₘₐₓ | 0.198 | 0.114 |

1. Nanoparticles of a functionalized and crosslinked polyvinylaromatic, which may be used especially as reinforcing filler in a polymeric matrix, wherein said polyvinylaromatic is a copolymer of at least:
a vinylaromatic comonomer “A”;
a comonomer “B” carrying a functional group denoted by Z of formula ≡Si—X, X representing a hydroxyl or hydrolyzable group;
a crosslinking comonomer “C” which is at least bifunctional and polymerizable by means of an addition reaction, it being possible for comonomer C to be vinylaromatic, in this case identical or different to comonomer A or non-vinylaromatic.

2. The nanoparticles according to claim 1, X being a halogen.

3. The nanoparticles according to claim 2, X being chlorine.

4. The nanoparticles according to claim 1, X satisfying the formula OR in which R represents hydrogen or a monovalent, linear or branched, hydrocarbon group.

5. The nanoparticles according to claim 4, R being selected from the group consisting of hydrogen, alkyls, alkoxyalkyls, cycloalkyls and aryls containing 1 to 15 carbon atoms.

6. The nanoparticles according to claim 5, R being selected from the group consisting of hydrogen, C₁-C₈ alkyls, C₂-C₈ alkoxyalkyls, C₅-C₁₀ cycloalkyls and C₆-C₁₂ aryls.

7. The nanoparticles according to claim 6, Z satisfying one of the formulae: 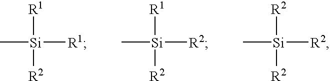
in which:
the radicals R¹, which are substituted or unsubstituted, identical or different, are selected from the group consisting of C₁-C₈ alkyls, C₅-C₈ cycloalkyls and C₆-C₁₂ aryls; and
the radicals R², which are substituted or unsubstituted, identical or different, are selected from the group consisting of hydroxyl, C₁-C₈ alkoxyls and C₅-C₈ cycloalkoxyls.

8. The nanoparticles according to claim 7, the radicals R¹ being selected from the group consisting of C₁-C₄ alkyls, cyclohexyl and phenyl.

9. The nanoparticles according to claim 8, the radical R¹ being selected from the group consisting of C₁-C₄ alkyls.

10. The nanoparticles according to claim 7, the radicals R² being selected from the group consisting of hydroxyl and C₁-C₆ alkoxyls.

11. The nanoparticles according to claim 10, the radicals R² being selected from the group consisting of hydroxyl and C₁-C₄ alkoxyls.

12. The nanoparticles according to claim 11, the radicals R¹ being selected from methyl and ethyl, and the radicals R² being selected from the group consisting of hydroxyl, methoxyl and ethoxyl.

13. The nanoparticles according to claim 1, the predominant weight fraction of the copolymer being a vinylaromatic fraction.

14. The nanoparticles according to claim 1, the vinylaromatic comonomer or comonomers being selected from styrene comonomers.

15. The nanoparticles according to claim 14, the styrene comonomers being selected from the group consisting of styrene, ethylvinylbenzene, divinylbenzene and mixtures of such monomers.

16. The nanoparticles according to claim 1, comonomer B being selected from the group consisting of hydroxysilyl(C₁-C₄)alkyl acrylates and methacrylates, (C₁-C₄)alkoxysilyl(C₁-C₄)alkyl acrylates and methacrylates and mixtures of such monomers.

17. The nanoparticles according to claim 16, comonomer B being selected from the group consisting of hydroxysilyl(C₁-C₄)alkyl acrylates and methacrylates, methoxysilyl(C₁-C₄)alkyl acrylates and methacrylates, ethoxysilyl(C₁-C₄)alkyl acrylates and methacrylates and mixtures of such monomers.

18. The nanoparticles according to claim 17, comonomer B being selected from the group consisting of hydroxysilylpropyl acrylates and methacrylates, methoxysilylpropyl acrylates and methacrylates, ethoxysilylpropyl acrylates and methacrylates, and mixtures of such monomers.

19. The nanoparticles according to claim 18, comonomer B being trimethoxysilylpropyl acrylate or trimethoxysilylpropyl methacrylate.

20. The nanoparticles according to claim 1, comonomer B being selected from the group consisting of styryl(C₁-C₄)alkylhydroxysilanes, styryl(C₁-C₄)alkyl(C₁-C₄)alkoxysilanes and mixtures of such monomers.

21. The nanoparticles according to claim 20, comonomer B being selected from the group consisting of styryl(C₁-C₄)alkylhydroxysilanes, styryl(C₁-C₄)alkylmethoxysilanes, styryl(C₁-C₄)alkylethoxysilanes and mixtures of such monomers.

22. The nanoparticles according to claim 21, comonomer B being selected from the group consisting of styrylethylhydroxysilanes, styrylethylmethoxysilanes, styrylethylethoxysilanes and mixtures of such monomers.

23. The nanoparticles according to claim 22, comonomer B being styrylethyltrimethoxysilane.

24. The nanoparticles according to claim 5, the molar content of comonomer B in said polyvinylaromatic being greater than 5%.

25. The nanoparticles according to claim 24, the molar content of comonomer B in said polyvinylaromatic being between 5 and 30%.

26. The nanoparticles according to claim 25, the molar content of comonomer B in said polyvinylaromatic being between 5 and 20%.

27. The nanoparticles according to claim 1, comonomer C carrying at least two polymerizable unsaturated groups.

28. The nanoparticles according to claim 27, the polymerizable unsaturated groups being ethylenic groups.

29. The nanoparticles according to claim 1, the polyvinylaromatic being obtained by radical polymerization.

30. The nanoparticles according to claim 1, comonomer C being selected from the group consisting of di(meth)acrylates of polyols, alkylene di(meth)acrylamides, vinylaromatic compounds carrying at least two vinyl groups, and mixtures of such comonomers.

31. The nanoparticles according to claim 30, comonomer C being a styrene compound.

32. The nanoparticles according to claim 31, the styrene compound being selected from the group consisting of diisopropenylbenzene, divinylbenzene, trivinylbenzene and mixtures of these comonomers.

33. The nanoparticles according to claim 1, the weight content of comonomer C in said polyvinylaromatic being greater than 5%.

34. The nanoparticles according to claim 33, the weight content of comonomer C in said polyvinylaromatic being between 10 and 30%.

35. The nanoparticles according to claim 32, comonomer C being divinylbenzene.

36. The nanoparticles according to claim 35, the polyvinylaromatic being a copolymer of styrene, ethylvinylbenzene, divinylbenzene and trimethoxysilylpropyl(meth)acrylate.

37. The nanoparticles according to claim 36, the weight content of trimethoxysilylpropyl(meth)acrylate being between 10 and 30%.

38. The nanoparticles according to claim 37, the weight content of trimethoxysilylpropyl(meth)acrylate being between 20 and 30%.

39. The nanoparticles according to claim 1, the mean diameter of the nanoparticles being between 10 and 100 nm.

40. The nanoparticles according to claim 39, the mean diameter of the nanoparticles being between 10 and 60 nm.

41. The nanoparticles according to claim 40, the mean diameter of the nanoparticles being between 10 and 40 nm.

42. A polymeric matrix comprising the nanoparticles according to claim 1.

43. The polymeric matrix according to claim 42, the polymer of the polymeric matrix being an elastomer.

44. A finished article or semi-finished product comprising rubber and the polymeric matrix according to claim 43.

45. A tire comprising the finished article or semi-finished product according to claim 44.

46. A masterbatch comprising nanoparticles according to claim 1 which are embedded in a polymeric matrix.

47. The masterbatch according to claim 46, the polymer of the polymeric matrix being an elastomer.

48. A process for obtaining a masterbatch comprising at least a polymer and a filler in the form of nanoparticles, comprising the following steps:
a latex of the polymer and a latex of the filler in the form of nanoparticles are initially obtained;
the latices are intimately mixed;
the mixture thus obtained is precipitated; and
the precipitate thus obtained is then washed and dried,
wherein said filler comprises nanoparticles of a polyvinylaromatic carrying a functional group denoted by Z of formula ≡Si—X, X representing a hydroxyl or hydrolyzable group.

49. A polymeric composition comprising at least a polymer, nanoparticles according to claim 1 and a coupling agent for bonding between the polymer and the surface of the nanoparticles.
